(19) United States
(12) Patent Application Publication
(10) Pub. No.: US 2014/0044951 A1
(43) Pub. Date: Feb. 13, 2014

(54) HIGH STRENGTH-TO-DENSITY NANOCELLULAR FOAM

(71) Applicants: James T. Beals, West Hartford, CT (US); Dilip M. Shah, Glastonbury, CT (US); Paul M. Sheedy, Vernon, CT (US); Donald L. Anton, Aiken, SC (US)

(72) Inventors: James T. Beals, West Hartford, CT (US); Dilip M. Shah, Glastonbury, CT (US); Paul M. Sheedy, Vernon, CT (US); Donald L. Anton, Aiken, SC (US)

(73) Assignee: UNITED TECHNOLOGIES CORPORATION, Hartford, CT (US)

(21) Appl. No.: 13/570,954

(22) Filed: Aug. 9, 2012

(51) Int. Cl. B32B 5/18; B01J 19/08; F01D 5/14; B29C 67/24; B82Y 40/00

(52) U.S. Cl. 428/221; 416/241 A; 264/414; 427/457; 977/840

(57) ABSTRACT

A nanocellular foam has pores, interconnecting ligaments, and nodes where three or more ligaments intersect. The ligament cross section thickness is less than 200 microns and the distance between nodes is less than 1000 microns. A method of fabricating a nanocellular foam comprising forming a compact with one or more powders and applying energy to cause at least one or more powders to undergo a change in state is disclosed.

### CROSS-REFERENCE TO RELATED APPLICATION(S)

Reference is made to application Ser. No. ______ (Attorney Docket No. PA0014533U-U73.112-700KL) entitled “Nanocellular Seal Material” by J. T. Beals et al., which is filed on even date and is incorporated by reference.

### BACKGROUND

The strength-to-weight ratio or the strength-to-density ratio, i.e. the specific strength, are important design criteria for mechanical systems. This is particularly true in gas turbine engines where even small savings in weight result in significant gains in engine efficiency. In this regard, cellular solids, variously referred to as foams or porous materials, can be used as structural components in gas turbine engines, so long as required specific strength values can be reached in the material and component.

As known in the art, conventional metallic foams can be produced from compacted powders containing blowing agents, such as adsorbed gases, that decompose when the metal powder is heated above its melting point. The gas foams the melt producing a porous solid upon solidification. Metal foams of this type typically have pores in the millimeter size range and with mechanical properties not suitable for gas turbine application.

Metal, intermetallic and ceramic foams with pore sizes and architectures scaled to the submicron or nano size range are a new class of materials with particular application as cellular materials in gas turbine engines.

### SUMMARY

Nanocellular foams are disclosed. In one embodiment, nanocellular foam can be described as having interconnecting ligaments, nodes where three or more ligaments intersect, and pore space between the ligaments. The ligament cross section thickness is about 5 nanometers to about 200 microns and the distance between nodes is about 15 nanometers to about 1000 microns.

In another embodiment, a method of fabricating a nanocellular foam is disclosed wherein the method comprises forming a compact with one or more powders and applying energy to the compact to cause the at least one or more powders to undergo a change in state to form a ligamented structure with a cross section thickness of about 5 nanometers to about 200 microns and a distance between nodes of about 15 nanometers to about 1000 microns.

In a further embodiment, a method for fabricating a nanoceullar foam comprises solution-based processing methods wherein elemental constituents are dissolved in a solution that can be uniformly and accurately applied to powder constituents, fugitive templates or foamed on its own to create a ligamented structure with a cross section thickness of about 5 nanometers to about 200 microns and a distance between nodes of about 15 nanometers to about 1000 microns.

### BRIEF DESCRIPTION OF THE DRAWINGS

FIG. 1 is a schematic representation of a foam.

FIG. 2 is a plot illustrating the specific strength and Young's Modulus variability achievable with nickel and silicon carbide nanocellular foams.

FIG. 3 is a flow chart showing a process to produce nanocellular foam.

FIGS. 4A and 4B are photomicrographs of nanocellular MoSi₂ foam before and after thermal processing.

FIGS. 5A-5D are photomicrographs showing different MoSi₂ nanocellular foam microstructures.

### DETAILED DESCRIPTION

The mechanical or structural properties of foams can be modeled based on standard elasto-plastic analysis of the ligament skeleton. Analytically derived predictions are more complex, incorporating effects of ligament geometry, the architecture of the cellular solid and the prediction of a mechanical property, M, such as Young's modulus, yield strength, fracture strength or fracture toughness. In general, the mechanical properties scale to the ratio of the densities, ρ_{c}, of the cellular solid and ρₛ the density of the dense solid matter as:

M_{c}=Mₛ·(ρ_{c}/ρₛ)ⁿ·f(ligament architecture) (1)

where the suffix c refers to the cellular solid and the suffix s refers to the dense solid (made of identical material). The exponent, n, is dependent on the type of mechanical properties. In reality, experimental values tend to be lower than those predicted by the models or even a simple rule of mixtures.

It is not, however, so easily recognized that such a cellular material with 50% porosity can also be made with pore and ligament sizes in the range of 0.01 to 200 microns that are not visible to the naked eye and wherein the structural behavior of ligaments and the pores is not treatable using conventional processes (?)e. For all practical purposes, such a material may appear like a “dense” solid. For example, even if such a nanocellular material had an open cell structure, the air flow or fluid flow through such pores may face an unprecedented surface tension resistance. Based on well recognized principles discussed below, the potential to achieve unprecedented, high strength-to-density, unusually high strain tolerance, and other unusual combinations of physical and material properties exists with such a material when ligament sizes fall below some threshold.

Achieving high deflection or apparent “ductility” in a thin brittle material illustrates the need to consider the absolute size of a material. In brittle materials, it is well recognized that, decreasing the volume of material results in a decrease in the crack-initiating defect density and an increase in fracture strength. This is well exploited in manufacturing of high strength whiskers and fibers of ceramic materials such as, Al₂O₃, SiC, Si₃N₄, glass, and metallic glass.

The strengthening of metals critically depends on the scale of the microstructure. Examples of such strengthening in dense metals are seen through grain refinement (i.e. Hall-Petch effect) or precipitation or dispersion strengthening and it is well known that when free standing material dimensions are approximately 1000 to 10,000 times the Burgers vector, as in whiskers, statistically the dislocation density becomes so low that material starts displaying strength approaching theoretical.

It is well recognized in the classical handbook by Peterson (Stress Concentration Design Factors by R. E. Peterson—1953) for assessing elastic stress concentration of notches of various shapes that notch sensitivity of steels decreases when the notch radius drops below 0.050 inches or 1,270 microns. This size effect is not anticipated in the framework of classical continuum elastic theory, the solution of which depends only on the relative dimension ratios. This challenges conventional thinking that all pores in a porous material are potential stress concentration sites and therefore potential failure sites, irrespective of size.

A key and well recognized point is that the mechanical behavior of materials such as strength, ductility, and even stress distribution are size dependent. Incorporation of this size dependent deviation of material properties from bulk behavior in fine scale nanocellular ligaments is the key concept of this invention.

Based on experimental data for metals and ceramic whiskers, and a wide range of recent work where the new technology has enabled testing of a variety of materials as free standing nanopillars, it is clear that strength, a, follows a power-law relationship with the size, d, as follows:

σ=Ad⁻ⁿ (2)

where σ is measured in MPa and d is measured in nm, and A≈1×10⁴ to 1×10¹⁰ and nβ0.5 to 1.5.

It is easy to see from the relationship that for n approaching 1.5, every 10× decrease in diameter leads to >25× increase in strength. The size range in which this rapid rise in strength over the bulk material strength occurs varies from material to material and can be sensitive to the process by which the material is made. The available experimental data suggests that the threshold is in the range of 100 microns for brittle material and is of the order of 10 microns for ductile metals.

In addition to applied mechanical stresses, in practice, dense high-temperature structural materials are always subjected to thermal stresses as a result of thermal gradients, ΔT. Thermal gradients impose a strain on the material as a result of thermal expansion. The imposed strain then generates a stress on the material, σ, which is proportional to its Young's modulus, E, in the direction of the thermal gradient and strain, as expressed by the following relationship:

σ=EαΔT (3)

where α is the coefficient of thermal expansion (CTE).

The imposed stress varies as the thermal gradient varies with heating, holding and cooling cycles, and with other structural loading, all of which then cause the material to fail by thermal mechanical fatigue. From Equation (3) it is clear that, for dense solids, a lower Young's modulus, E, and α, will lower the imposed stress, σ. For cellular solids, the reduced density similarly results in a reduced Young's modulus and a drop in imposed thermal stress.

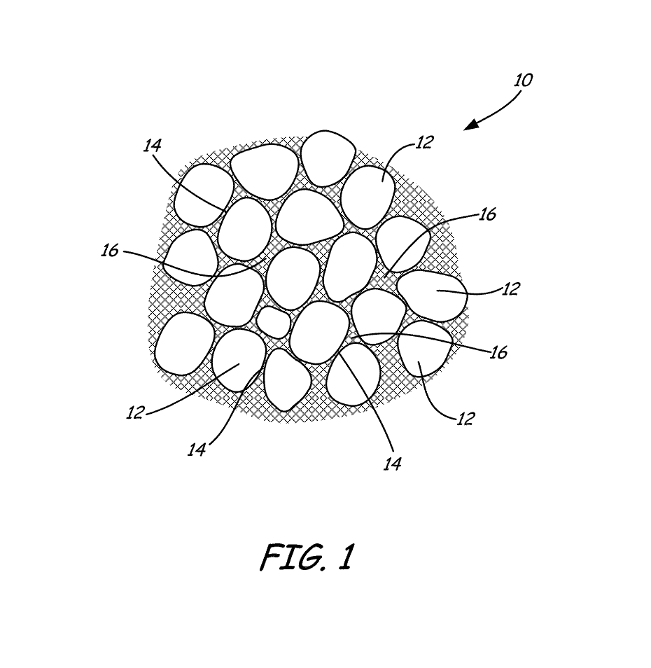

A schematic illustration of a cellular solid variously referred to as a foam or porous material is shown in FIG. 1. Foam 10 comprises ligaments 14 and nodes 16 surrounded by pores 12. Nodes 16 are defined as the junction of three or more ligaments.

The innovation and core basis of this invention is that, if cellular solids are made with adequate microstructural control, then it is not necessary for the performance of cellular solids to be bound by a simple “rule of mixtures”. The innovation rests on two key building blocks: (a) a conceptual understanding that, if the cellular solids are built with ligament sizes approaching 100 to 100,000 times the atomic dimensions, mechanical behavior cannot be assumed to be identical to that of a bulk solid, and (b) primary focus of this innovation is the size of ligaments and not just ligament architecture, or the size and volume fraction of pores.

Combining the ligament strength relationship stated in equation (2) with the foam property relationship stated in equation (1), it is easy to show that the predicted strengths of nanocellular materials can easily surpass traditional cellular solids as well as dense, bulk materials if the ligament size is sufficiently below the threshold at which material properties become increasingly size dependent.

Thus specifically,

σ_{c}=σₓ·Ad⁻ⁿ·(p_{c}/pₛ)ⁿ·f(ligament architecture) (4)

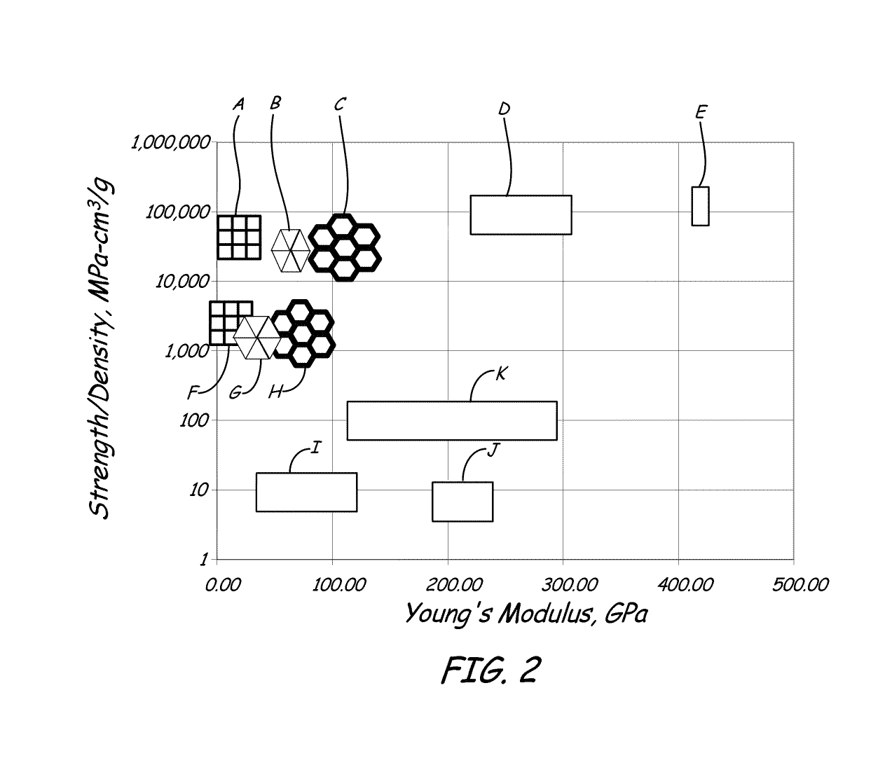

Using a similar analysis applied to square, triangular, and honeycomb cellular architectures and published data on SiC and Ni whiskers, the strength-to-density ratio of hypothetical nanocellular materials with ligament thicknesses in the range of 500-1000 nm can be modeled. FIG. 2 shows this strength-to-density data plotted against Young's modulus since it is specifically meaningful for nanocellular materials for high temperature structural applications. Also shown are comparative values for many dense solid systems.

Indicators for the fields shown in FIG. 2 are shown below:

| Symbol | Material | Structure |
|---|---|---|
| A | SiC | Square nanocellular foam |
| B | SiC | Triangular nanocellular foam |
| C | SiC | Hexagonal nanocellular foam |
| D | SiC | Dense |
| E | SiC | Whisker |
| F | Ni | Square nanocellular foam |
| G | Ni | Triangular nanocellular foam |
| H | Ni | Hexagonal nanocellular foam |
| I | Ni | Conventional Cell foam |
| J | Ni | Dense |
| K | Ni | Whisker |
| L | Ni base | Dense equiaxed, and directionally solidified |
| | superalloys | columnar grain or single crystal |

It is apparent from the figure that the specific strengths of nanocellular nickel foams with 500-1000 nm ligaments are superior to both conventional nickel foams and even dense nickel base superalloys. In addition, the moduli of both nickel and SiC nanocellular foams are a function of cell structure and can be intentionally varied.

With appropriate design, a cellular structure can actually be more strain tolerant than the simple predictions by Equation (4). In particular, in nanocellular solids with finer cell sizes and stronger ligaments, the material can tolerate sharper thermal gradients by locally absorbing the stress by distorting individual ligaments elastically (i.e. the higher strength and lower modulus allows for higher elastic strain). This results in improved thermal fatigue resistance since constraining effects that cause high stresses in dense materials are absent. Both of these characteristics are inherent in the nanocellular material of the invention as discussed before. This opens up design space for strengthening smaller features, such as cooling holes in turbine blades, which are normally stress concentrators, since such features will be hundreds of times coarser than the cell size in nanocellular materials.

In summary, the benefit of nanocellular structures results from decoupling the mechanical properties of a material from its bulk behavior by exploiting the strong size effect on properties when the material dimensions are reduced below a certain threshold ligament size. The overall decrease in the cell size and ligament size in nanocellular material not only leads to a high strength-to-density ratio but also a higher strain tolerance in thermal environments with improved thermal fatigue resistance. This, in particular, can enable application of brittle high temperature materials, such as intermetallic silicides and aluminides for gas turbine engine applications.

The elimination of local constraints in nanocellular materials is also enabling for non-cubic materials with anisotropic CTE such as Ti₅Si₃. Dense, non-cubic materials are sometimes self destructive in polycrystalline form, as each grain imposes stress at a grain boundary owing to anisotropic thermal contraction. In this context it is critical to bring the ligament size below a threshold at which bulk behavior is not emulated. Processing such compounds as nanocellular structures may help suppress such behavior.

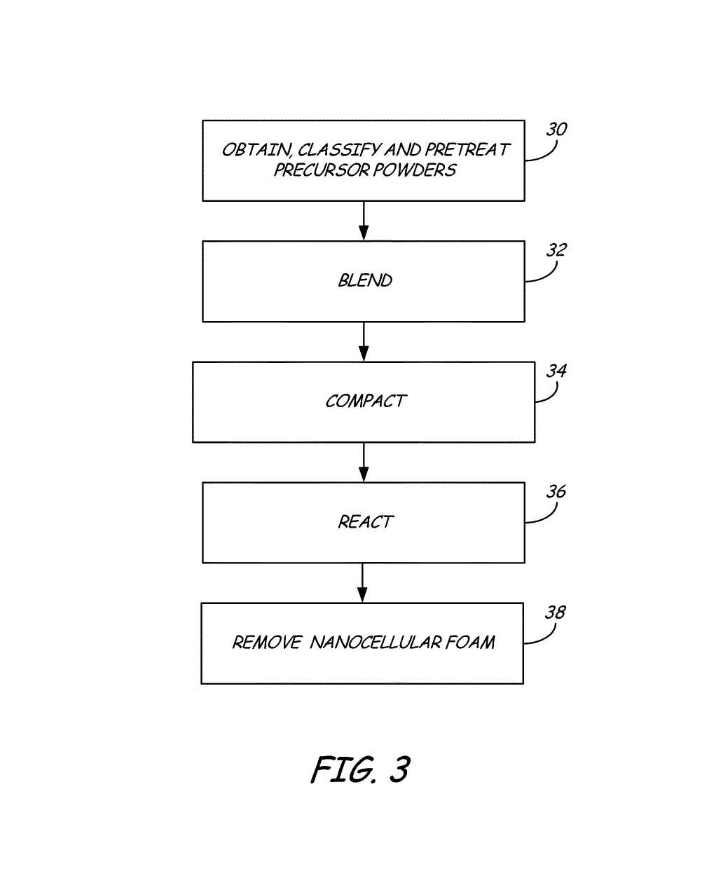

One method of producing nanocellular materials is shown in FIG. 3. In the first step, precursor materials are obtained, preferentially in powdered form, and are pretreated, if necessary, and classified according to size (Step 30). In the next step, at least two precursors are blended together to form a homogeneous mixture (Step 32). Following blending, the mixture is compacted using a binder in certain instances (Step 34). The compacted mixture is then reacted, as mentioned earlier, to form a nanocellular foam. It is important that at least one constituent undergo a phase transformation, usually a thermally or chemically induced change in state, which then reacts with another constituent to form a new phase or compound thereby generating a ligament structure (Step 36). A nanocellular foam thus formed is then removed from the reactor (Step 38).

In an embodiment, as mentioned above, a nanocellular material can be made by compacting powders of two or more materials wherein, upon applying energy to the composite, causes at least one of the materials to undergo a change in state that results in the formation of a ligament structure. That change in state can comprise melting, selective or transient melting, welding, evaporating, chemically reacting, solid state diffusion and combinations thereof.

In another embodiment, polymer particles may be added to the initial powder to vary the density of the final product.

### Example 1

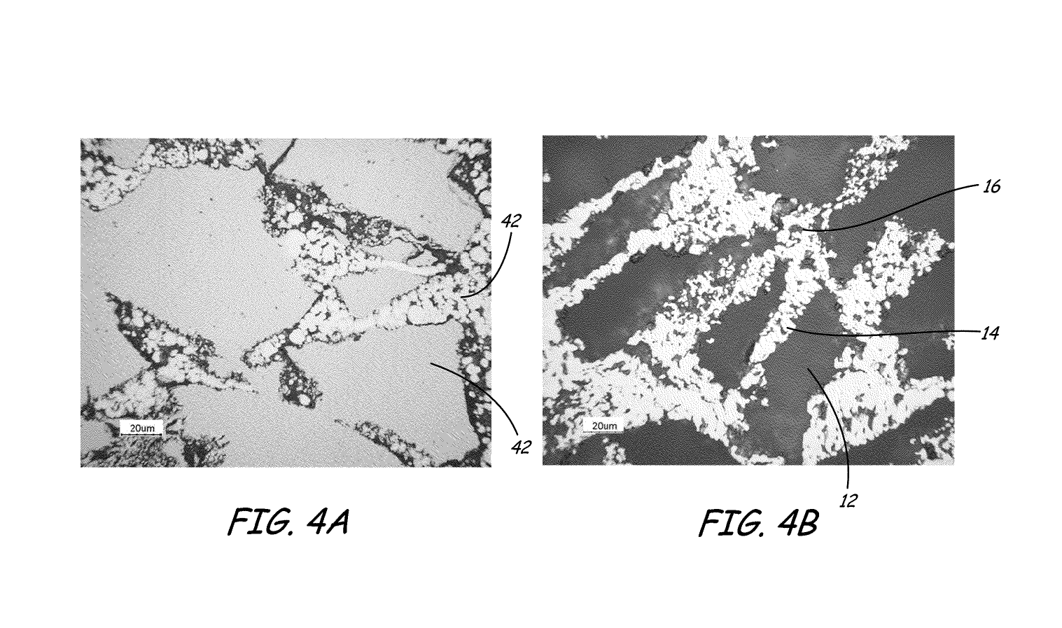

As an example, a nanocellular MoSi₂ foam was produced by a powder metallurgical process. In this processing approach elemental Mo, and Si powders (step 30) were mixed in the correct stoichiometric proportion of 33.3 atom % of Mo+66.6 atom % of Si, to make MoSi₂ (Step 32). The blended powder mixture was hot pressed at sufficiently low temperatures as not to react the elemental species, in this case, less than 1000° C. (Step 34). A photomicrograph of as-compacted Si/Mo powder is shown in FIG. 4A. Larger Si particles 20 are surrounded by finer Mo particles 22. Subsequently the compact was heat treated at a temperature slightly below the 1410° C. melting point of Si. Local reaction of Mo and Si ensued, resulting in Si melting and diffusing into the surrounding Mo ligament skeleton structure (Step 36). This led to in situ formation of a MoSi₂ cellular structure with porosity created at sites formerly occupied by Si powder. The process is greatly helped by the exothermic reaction between Mo and Si leading to the formation of high-melting and more stable MoSi₂ intermetallic. A photomicrograph of the structure after foaming is shown in FIG. 4B. MoSi₂ ligaments 14 and nodes 16 are shown encasing pores 12 (Step 38).

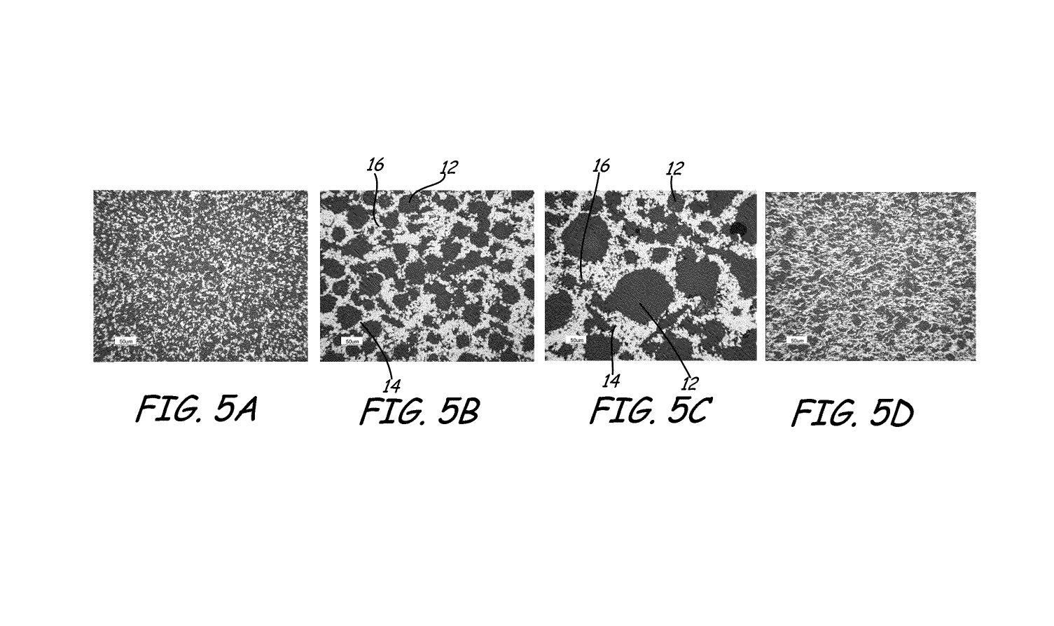

Four different cellular architectures of MoSi₂ nanocellular foam are shown in FIGS. 5A-5D. In FIG. 5A, the foam was produced using equivalent sized Mo and Si powder. In FIG. 5B, the foam was produced using spherodized Si powder to produce spherical pores 12. In FIG. 5C, bimodal spherical Si powder was used to produce spherical pores 12 with a bimodal size distribution. In FIG. 5D, the foam was produced using Mo powder in the form of platelets. In an embodiment, if hollow Si powder were used, a higher volume fraction of porosity will result.

In another embodiment, powder based methods of forming nanocellular foams may be combined with solution based processing procedures to achieve greater microstructural control. In these processes, precursors of at least one of the starting components of a future nanocell structure may be in the form of a solution. Other components of the system, such as powders, whiskers, etc. may then be coated with the solution and thermally and/or chemically treated to form a coating of at least one precursor on the solid components. Typically, the coatings are reduced or otherwise transformed to result in an elemental or compound material coating capable of reacting with the compacted base substrate to form the ligaments and nodes of a nanocell structure.

### Example 2

In an example, experiments were performed with precursor MoO₃ and Si. As a starting point, Mo metal was dissolved in hydrogen peroxide to form a moly-oxy-peroxide solution. Si powder particles were then treated with the solution to form a uniform MoO₃ coating on the particles. The coated particles were then treated in a reducing atmosphere to produce Mo coated Si powder particles (Step 30). The particles were then compacted (Step 34) and heat treated (Step 36) as above to form a nanocellular foam comprising MoSi₂ ligaments 14 and nodes 16 encasing pores 12 as shown in the example of FIG. 4B (Step 38).

In a variant of the process, polymer templates such as PMMA microspheres may be coated first with a Si containing solution and then with the molyl-oxy-peroxide solution, to form a MoO₃ coating on the Si layer. The coated particles are then treated in a reducing atmosphere to form Mo and Si coated PMMA microshperes. The coated PMMA microspheres can be added to the Mo coated Si particles, compacted and treated as before to produce MoSi₃ nanocellular structures with controlled porosity as a result of volatilization of PMMA during the heat treatment.

In another embodiment, polymer template particles can be coated with two or more precursor material solutions and treated to produce intermetallic compound nanocellular structures with controlled porosity.

### Example 3

In another embodiment, a simple binary nickel aluminide foam may be produced by reacting elemental Ni and Al powders. Ni and Al powders are first blended (Step 32). The powders are then compacted at a temperature of 450° C. (Step 34). The compact is then heated to temperatures exceeding 640° C. to react the powders (Step 36). It is presumed that low melting Al will melt and wick into the higher melting Ni powders skeleton forming a nickel aluminide nanocellular foam. Following processing, the useful foam is removed (Step 38).

In accordance with this invention, a nanocellular foam is defined as a foam wherein the ligament minimum dimension is from about 5 nm to about 200 μm and the distance between nodes is from about 15 nm to about 1000 μm. In an embodiment, the ligament cross section thickness is from about 5 nm to about 10 μm and the ligament length is at least three times the cross section thickness. Further in accordance with this invention, a nanocellular foam may be a metal, intermetallic compound, ceramic, metastable phase such as glass, metallic glass, or mixtures thereof. The foam may be an open or closed cell structure, or a combination thereof. Further, in accordance with this invention, the foam may have a porosity ranging from about 5% to about 95%. In an embodiment, the pore size of the nanocellular foam of the invention may be from about 5 nanometers to about 100 microns, more specifically, the pore size may be from about 100 nanometers to about 20 microns.

In an embodiment, fibers, whiskers, nanotubes, hollow spheres, coated powders, coated fibers, coated whiskers, fumigating compound powders, and other forms known in the art may be used to form the powder compact. The minor dimension (i.e. the powder, fiber, or whisker diameter) of the precursor materials may be from about 5 nanometers to about 100 microns, more specifically from about 5 nanometers to about 20 microns.

In an embodiment, the powder may be cryomilled prior to mixing to achieve a finer size and structure. Furthermore, the powder may be mixed and extruded to achieve greater intermixing of constituents and/or alignment of powder shapes.

In another embodiment, the powders may be electrostatically or magnetically aligned while compacting.

In another embodiment, the powder metallurgical approach allows the introduction of chemical activators and reducers. Introduction of these agents may enable in situ production of metal nanocellular foams from halides, hydrides, or other inorganic and organic metallic precursor compounds and subsequently allow achieving ligament integrity by incorporating a high temperature partial melting and reactive synthesis process.

It should be apparent from the above examples that generation of the desired shapes and sizes of the nanocellular architecture, e.g. ligaments and pore space, will be dependent on the shapes, sizes and size distributions of the starting powder or powders.

A wide range of intermetallics and metallic alloys as well as ceramic materials such as Sic may be fabricated including silicides, aluminide intermetallics, ternary intermetallics, carbides, oxides, silicates, nitrides, ternary or multicomponent compounds, MAX phases, and combinations thereof. TiAl, NiTi, NiAl, Ti₅Si₃, and MAX phases, such as Ti₃SiC₂, are examples. Ni-based, Co-based, and Fe-based superalloy foam compositions may also be produced, whereby the intermetallic gamma prime precipitate, Ni₃Al, and Ni-rich matrix phases may be formed in situ. Incorporation of additional porosity into these structures may also be augmented through use of polymer templating.

A judicious selection of pre-alloyed or intermetallic compound powder may allow different levels of porosity distribution and ligament sizes.

In another embodiment the powder metallurgy technique may be easily combined with a conventional foaming technique. Coated fumigating material powder may be incorporated in the process. As long as there is some sub-step that involves melting and wicking or diffusion of one or more of the components, a ligament structure with low defect density is possible.

Other pathways to achieve the final cellular microstructure may also be used.

The powder metallurgy process for producing nanocellular foams discussed herein is not and should not be taken as limiting. Other methods involving liquid and gaseous infiltration of precursor structures, thermal, and chemical leeching of multi-phase precursor structures, self-assembly, and other methods readily ascertainable by one skilled in the art are included.

As mentioned above, powder based methods may be combined with solution based processing. In an embodiment, polymer templates such as PMMA microspheres may be used to facilitate additional control of the nanocellular architecture through exploitation of self assembly mechanisms (e.g. block-copolymer self assembly), forming well defined nanostructures such as spheres, rods, lamellae, etc.

Structural applications of nanocellular material may be envisioned at several extremes with reference to a jet engine. If the nanocellular materials are made with fine scale ligaments and moderate levels of porosity, such that reasonable levels of elastic stiffness are maintained, the material may be used as high strength, light weight blade outer air seals, vanes, and blades. Application of such high strength-to-density, strain tolerant, thermomechanical fatigue resistant, nanocellular material as blades may have a cascading weight saving effect. Besides the direct weight saving for the component, the lighter weight leads to decreased centrifugal pull on the inner disk and shaft, enabling lighter design of those components as well.

Nanocellular materials with relatively high elastic moduli of greater than about 35 GPa can be used to advantage in any structural component in an application that benefits from a high specific strength. These materials may be used in non-rotating, static applications, such as in vanes and outer air seals in turbines in aircraft and in industrial applications. These materials may also be used to advantage in rotating or other dynamic motion applications where dynamic stresses are a critical part of the design. Examples include turbine blades and disks. A further area where these materials can be used to advantage is in any application where improved strain tolerance leads to thermal shock and thermal mechanical fatigue resistance.

Further, as with many traditional foams, nanocellular solids with appropriate ligament architectures may exhibit a negative Poisson's ratio. Such auxetic nanoceullar materials could expand in a transverse direction upon stretching and contract in the transverse direction under compression.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### DISCUSSION OF POSSIBLE EMBODIMENTS

A nanocellular foam can comprise pores, interconnecting ligaments, and nodes between the ligaments wherein the ligament cross section thickness or minimum dimension is from about 5 nanometers to about 200 microns and the distance between nodes is from about 15 nanometers to about 1000 microns.

A system of the preceding paragraph can optionally include additionally and/or alternatively any, one or more of the following features, configurations, and/or additional components:

a ligament cross section thickness or minimum dimension can be from about 5 nanometers to about 10 microns and the ligament length can be at least three times the ligament cross section thickness;

the porosity of the foam can be from about 5% to about 95%;

the pore sizes of the foam can be from about 5 nanometers to about 100 microns;

the pore sizes can be from about 100 nanometers to about 20 microns;

the foam can be a metal, intermetallic compound, ceramic, glass, glass ceramic, metallic glass, or mixtures thereof;

the foam can be a closed or open cell structure, or a combination thereof;

the foam can be selected from the group consisting of silicides, aluminide intermetallics, turnery intermetallics, carbides, oxides, silicates, nitrides, turnery or multicomponent compounds, metallic glasses, MAX-phases, superalloys, and mixtures thereof;

the foam can be selected from the group consisting of MoSi₂, TiAl, NiTi, NiAl, Ti₅Si₃, and Ti₃SiC₂;

the foam can be selected from the group consisting of nickel based, cobalt based, iron based superalloys, and mixtures thereof.

A method of forming a nanocellular foam can be by:

forming a composite of two or more precursor materials in particulate form with minor dimensions of less than 75 microns;

and applying energy to the composite to allow at least one of the precursor materials to undergo a change in state and form a ligament structure with a cross section thickness or minimum dimension of from about 5 nanometers to about 200 microns and a distance between nodes from about 15 nanometers to about 1,000 microns.

The method of the preceding paragraph can optionally include, additionally and/or alternatively, any, one or more of the following features, configurations, and/or additional components:

the precursor materials are in the form of a powder, whisker, fiber, hollow sphere, nanotube, fumigating compound powder, coated powder, and coated whisker;

the energy can be thermal, microwave, laser, electron beam energy, and ultrasonic vibration;

the precursor materials can be selected from the group consisting of metal, intermetallic compound, ceramic, glass, metallic glass, and mixtures thereof;

the minor dimension of the precursor materials can be from about 5 nanometers to about 200 microns;

at least two of the precursor materials can react to form a separate phase;

the precursor materials can have a bimodal or multimodal particle size distribution;

the precursor materials can be selected from the group consisting of silicides, aluminide intermetallics, ternary intermetallics, carbides, oxides, silicates, nitrides, turnery or multicomponent compounds, metallic glasses, MAX-phases, superalloys, and mixtures thereof.

A method of forming a nanocellular foam can be by:

forming a first precursor material solution;

coating a second precursor material in particulate form with the first precursor material solution;

treating the coated particles to form a first precursor material coating on the second precursor material particles;

forming a composite of the coated second precursor material particles;

and applying energy to the composite to allow at least one of the precursor materials to undergo a change in state to form a ligament structure with a cross section thickness or minimum dimension of from about 5 nanometers to about 200 microns with a distance between nodes of from about 15 nanometers to about 1,000 microns.

The method of the preceding paragraph can optionally include, additionally and/or alternatively, any, one or more of the following features, configurations, and/or additional components:

the second precursor materials are in the form of a powder, whisker, fiber, hollow sphere, nanotube, fumigating compound powder, coated powder, and coated whisker.

1. A nanocellular foam comprising pores, interconnecting ligaments, and nodes between the ligaments wherein the ligament cross section thickness or minimum dimension is from about 5 nanometers to about 200 microns and the distance between nodes is from about 15 nanometers to about 1000 microns.

2. The nanocellular foam of claim 1, wherein the ligament cross section thickness or minimum dimension is from about 5 nanometers to about 10 microns and the ligament length is at least three times the cross section thickness.

3. The nanocellular foam of claim 1, wherein the porosity of the foam is from about 5% to about 95%.

4. The nanocellular foam of claim 3, wherein the pore sizes are from about 5 nanometers to about 100 microns.

5. The nanocellular foam of claim 4, wherein the pore sizes are from about 100 nanometers to about 20 microns.

6. The nanocellular foam of claim 1, wherein the foam is a metal, intermetallic compound, ceramic, glass, glass ceramic, metallic glass, or mixtures thereof.

7. The nanocellular foam of claim 1, wherein the foam is a closed or open cell structure, or a combination thereof.

8. The nanocellular foam of claim 1, wherein the foam is selected from the group consisting of silicides, aluminide intermetallics, ternary intermetallics, carbides, oxides, silicates, nitrides, ternary or multicomponent compounds, metallic glasses, MAX-phases, superalloys, and mixtures thereof.

9. The nanocellular foam of claim 8, wherein the foam is selected from the group consisting of MoSi₂, TiAl, NiTi, NiAl, Ti₅Si₃, and Ti₃SiC₂.

10. The nanocellular foam of claim 8, wherein the foam is selected from the group consisting of nickel-based, cobalt-based, iron-based superalloys, and mixtures thereof.

11. The nanocellular foam of claim 1, wherein the nanocellular foam is configured for use in static components of a turbine engine.

12. The nanocellular foam of claim 11, wherein the static components comprise non-rotating vanes and outer air seals.

13. The nanocellular foam of claim 1, wherein the nanocellular foam is configured for components of a turbine engine with high dynamic loading.

14. The nanocellular foam of claim 13, wherein the components comprise turbine blades or disks.

15. The nanocellular foam of claim 1, wherein the nanocellular foam is configured for applications where resistance to thermal shock and thermal mechanical fatigue is required.

16. A method of forming a nanocellular foam comprising:
forming a composite of two or more precursor materials in particulate form and having a minor dimension of less than 75 microns; and
applying energy to the composite to allow at least one of the precursor materials to undergo a change in state and form a ligament structure with a cross section thickness or minimum dimension from about 5 nanometers to about 200 microns and a distance between nodes from about 15 nanometers to about 1000 microns.

17. The method of claim 16, wherein the precursor materials are in the form of a powder, whisker, fiber, hollow sphere, nanotube, fumigating compound powder, coated powder, and coated whisker.

18. The method of claim 16, wherein energy comprises thermal, microwave, laser, electron beam energy, and ultrasonic vibrations.

19. The method of claim 16, wherein change in state comprises melting, selective or transient melting, welding, evaporating, chemically reacting, solid state diffusion, and combinations thereof.

20. The method of claim 16, wherein the precursor materials are selected from the group consisting of metal, intermetallic compound, ceramic, glass, metallic glass, and mixtures thereof.

21. The method of claim 20, wherein the minor dimension of the precursor materials is about 5 nanometers to about 200 microns.

22. The method of claim 16, wherein at least two of the precursor materials react to form a separate phase.

23. The method of claim 16, wherein the precursor materials have a bimodal or multimodal particle size distribution.

24. The method of claim 16, wherein the precursor materials are selected from the group consisting of silicides, aluminide intermetallics, ternary intermetallics, carbides, oxides, silicates, nitrides, ternary or multicomponent compounds, metallic glasses, MAX-phases, superalloys, and mixtures thereof.

25. The method of claim 16, wherein polymer particles are added to the precursor materials to vary the density of the nanocellular foam.

26. The method of claim 16, wherein forming a composite of two or more precursor materials in particulate form comprises coating polymer template particles with first and second precursor material solutions.

27. A method of forming a nanocellular foam comprising:
forming a first precursor material solution;
coating a second precursor material in particulate form with the first precursor material solution;
treating the coated particles to form a first precursor material coating on the second precursor material particles;
forming a composite of the coated second precursor material particles; and
applying energy to the composite to allow at least one of the precursor materials to undergo a change in state and form a ligament structure with a cross section thickness or minimum dimension from about 5 nanometers to about 200 microns and a distance between nodes of from about 15 nanometers to about 1000 microns.

28. The method of claim 27, wherein the second precursor materials are in the form of a powder, whisker, fiber, hollow sphere, nanotube, fumigating compound powder, coated powder, and coated whisker.

29. The method of claim 27, wherein change in state comprises melting, selective or transient melting, welding, evaporating, chemically reacting, solid state diffusion, and combinations thereof.

30. The method of claim 27, wherein the nanocellular foam comprises a material with an elastic modulus greater than about 35 GPa and is required in load bearing structural applications.
